(19) United States
(12) Patent Application Publication
(10) Pub. No.: US 2020/0032019 A1
(43) Pub. Date: Jan. 30, 2020

(54) ELASTOMER COMPONENT EXPOSED TO BLOW-BY GASES OF AN INTERNAL COMBUSTION ENGINE

(71) Applicant: WOCO Industrietechnik GmbH, Bad Soden-Salmuenster (DE)

(72) Inventors: Sebastian Fenske, Gelnhausen (DE); Thomas Doell, Gelnhausen (DE); Xavier Nast, Colmar (FR)

(73) Assignee: WOCO Industrietechnik GmbH, Bad Soden-Salmuenster (DE)

(21) Appl. No.: 16/524,734

(22) Filed: Jul. 29, 2019

(30) Foreign Application Priority Data
Jul. 27, 2018 (DE) 102018118267.8

(51) Int. Cl. C08J 7/12; F16J 15/02; F16J 15/3284; F16J 9/26

(52) U.S. Cl. CPC C08J 7/126; F16J 15/022; F16K 15/14; F16J 9/26; F16J 15/3284

(57) ABSTRACT

An elastomer component, which is exposed to blow-by gases of an internal combustion engine, includes a function body made of a elastomer material and a fluorine layer arranged on the outside of the function body.

### RELATED APPLICATIONS

This application claims the benefit and priority of German Patent Application DE 10 2018 118 267.8, filed Jul. 27, 2018, which is incorporated by reference herein in its entirety.

### TECHNICAL FIELD

The invention relates to an elastomer component, which is exposed to blow-by gases of an internal combustion engine, in particular of a motor vehicle, such as a passenger car. The invention further relates to a use of the elastomer component and a method for producing the elastomer component.

### BACKGROUND

Blow-by gases are produced in an internal combustion engine or piston compressor when combustion gases can pass proportionately from the working chamber into the engine room. The portion of the combustion gas that is not retained is referred to as blow-by gas. U.S. Pat. No. 4,345,573 A describes a system wherein such blow-by gases are diverted back to the combustion chamber by mixing and combustion with a fresh air/fuel mixture.

The presence of blow-by gases is a particular challenge for the development of elastomer components. These are used, for example, as seals, valves, and diaphragms inter alia in internal combustion engines in vehicles and are regularly exposed to blow-by gases. In addition to carbon dioxide and possibly water, blow-by gases usually also include aggressive hydrocarbon compounds such as unburned fuels and engine oils. The constituents of blow-by gases also form corrosive acids. Heavy metals, such as manganese, may also be included. Blow-by gases are therefore highly complex mixtures that can damage elastomer components due to high temperatures and their chemical reactivity. Damaged elastomer components should be replaced, which involves costly maintenance. Newer applications in current combustion engines in particular produce more aggressive blow-by gas mixtures, which have critical effects on the elastomer components, especially on their storage behavior. For example, it has been shown that their aggressiveness is increasing due to a higher proportion of biofuels.

Elastomer components, which include fluorosilicones are known from prior art. Fluorosilicones can be used, for example, to produce elastomer components that reduce friction. DE 20 2014 010 065 U1 discloses an elastic diaphragm made of fluorosilicone rubber, which separates the blow-by gas flow from the control gas flow.

An object of one embodiment is to overcome the disadvantages of the state of the art, in particular to provide an elastomer component exposed to blow-by gases, which has improved chemical resistance to blow-by gases and may have a longer service life. In particular, it is also an object of an embodiment to provide a method for producing of and a use for said elastomer components. Conventional fluorosilicone components have limited resistance to the corrosive components of blow-by gases. Although components made of fluorinated elastomers are known, their chemical resistance to blow-by gases is unsatisfactory. According to an embodiment, an elastomer component exposed to blow-by gases of an internal combustion engine comprises a function body made of an elastomer material and a fluorine layer arranged on the outside of the function body.

The function body is formed by a first elastomer and the fluorine layer by a second elastomer. The first elastomer differs from the second elastomer only in that the second elastomer, which is to form the fluorine layer, contains fluorine in a higher concentration than the first elastomer of the function body. The base elastomer material of the function body and the fluorine layer can be identical, whereby the second elastomer, which forms the fluorine layer, is formed only by enrichment of fluorine. The first elastomer may differ from the second elastomer only in that fluorine is incorporated in the elastomer material of the fluorine layer in order to form the fluorine layer on the outside, in which the fluorine concentration is significantly higher, by at least 10%, 20%, 50%, 70%, 90%, than in the elastomer material of the function body.

The function body of the elastomer component is a solid body in which a fluorine layer is arranged on the outside of the function body. The fluorine layer completely covers the outside of the function body. It is clear that the function body can also be formed as a hollow body, whereby the fluorine layer should be arranged on the outside of the functional hollow body. The fluorine layer is designed with a constant concentration in its course around the function body, whereby the fluorine concentration can also vary, particularly it can be higher on a side of the elastomer component, which is more exposed to the blow-by gas than an opposite side in particular. This may be particularly relevant in the case of a disc-shaped elastomer component, which, for example, is designed as a valve member.

The entire elastomer component may be composed wholly or partly of the two different elastomers, wherein the second elastomer, in particular the second elastomer material, is a forming part of the fluorine layer and the first elastomer, in particular the first elastomer material, is a forming part of an elastomer core of the component. The function body comprises said elastomer core, in particular consisting of it. It has been shown that the elastomer of the fluorine layer, which is mixed with fluorine, produces an improved chemical resistance of the elastomer component, while the elastomer core maintains the functionality with regard to the longer period of usage under stress, such as elasticity, and is not affected by the fluorine. The fluorine layer on the outside of the elastomer core serves as a barrier, while the functionality is achieved through the interior of the elastomer core.

The fluorine layer can be formed by fluorinating the elastomer material, which in particular also forms the core. Fluorination is the introduction of fluorine into compounds, in particular organic compounds, by means of fluorinating agents. The fluorinating agent of the present invention is gaseous fluorine (F2). The compound, in particular organic compound, is an elastomer material. When fluorine reacts with the elastomer, hydrogen fluoride is usually released. Such elastomers, in which carbon is contained in a covalent compound with hydrogen, are also referred to as organic compounds or organic elastomers, which may, for example, be a siloxane with organic substituents or groups. Because of fluorination, the fluorine layer has a higher fluorine content than the function body, especially with organic residues resulting from fluorination, which were not present in the elastomer material before fluorination.

In one embodiment, the fluorine layer and the function body are formed from the same elastomer material, wherein the fluorine layer, in particular in contrast to the function body, is formed by adsorption, in particular incorporation, of fluorine into the elastomer material, is inserted in particular by fluorination of the surface of the function body in its elastomer material, wherein in particular by the introduction of fluorine an adsorption of the fluorine atoms, in particular by substitution of hydrogen with fluorine, is achieved on the polymer chains of the elastomer material, in particular on the surface of the function body. A side of the function body, which is to be facing the blow-by gas, is provided with the fluorine layer, and the function body may be completely enclosed by the fluorine layer.

According to one embodiment of a function body, which may be a solid body, is formed from an elastomer material in order to perform the specific function of the elastomer component. For example, the function body may be formed by the shape of a valve member, which may have different shapes. For example, the function body is plate-shaped and may in particular have one or more, in particular concentric, rotational convexities and concavities in order to perform the function of the valve member according to the requirements. The valve member may be rotation-shaped and can also have complicated shapes such as a mushroom shape. At the same time, the function body also has undercuts.

In accordance with an embodiment, the function body is provided with a fluorine layer arranged on the outside of the function body, which serves in particular to prevent permeation, penetration or migration of aggressive components of the blow-by gas, for example acids and/or heavy metals. A fluorine layer on the outside of the function body, which has an increased fluorine concentration than the rest of the interior or elastomer core of the function body, on the one hand provides excellent defense against the aggressive media and on the other hand the functional capability of the elastomer part remains unimpaired even after long-term tests. The measure also makes it possible to use inexpensive elastomer materials such as fluorocarbon rubber. Furthermore, it turned out surprisingly that the formation of ice coating, in particular a freezing of H2O as condensate on the elastomer component, can be avoided, or at least reduced by the fluorine layer. Even at low temperatures, especially at temperatures as low as −30° C., it was possible to avoid or at least reduce ice coating. One explanation for this is that condensation water, which condenses on the elastomer component from air heated by the motor, can flow off better because of the fluorine layer and accumulations of condensation water, in particular condensation deposit, on the elastomer component according to an embodiment can thus be prevented or at least reduced. In this way, the functional efficiency of the function body is preserved even at low temperatures, for example a vent valve or pressure relief valve in an oil separator attached to the crankcase.

The function body or elastomer component can perform various functions, such as sealing or opening and closing for a control valve. The function body is generally realized by having a certain elasticity with respect to the forces to which the function body is exposed, wherein the function body in particular is movably mounted. The function body must be able to endure different operating forces and to adopt different degrees of deformation. Examples of how the elastomer component works will be described below.

The fluorine layer can also be targeted at corresponding mixtures of polymer chains of the base elastomer material with varying degrees of fluorine, wherein more or less hydrogens are substituted by fluorine by means of fluorination. It is also possible that fluorination does not affect some polymer chains at all, so that fluorinated and non-fluorinated polymer chains are present in parallel in one area. Some polymer chains are not additionally fluorinated, while other polymer chains have a higher fluorine content than the base elastomer material due to the reaction with fluorine. It may be intended that the fluorine layer consists of at least 50% by weight, in particular at least 60% by weight, in particular may be at least 80% by weight, of fluorinated polymer chains. It may also be intended that only those areas of the elastomer component which consist of at least 50% by weight, in particular at least 60% by weight, in particular may be at least 80% by weight, of fluorinated polymer chains belong to the fluorine layer. Furthermore, it may be expedient that the function body, in particular the elastomer core, directly adjoins the fluorine layer, in particular wherein the elastomer component consists of function body and fluorine layer, in particular of elastomer core and fluorine layer. The function body, in particular the elastomer core, may include predominantly, i.e. more than 50% by weight, or consists entirely of non-fluorinated polymer chains. If the elastomer core consists entirely of non-fluorinated polymer chains, all proportionally or fully fluorinated areas may be assigned to the fluorine layer. In one embodiment, the elastomer component itself furthermore consists entirely of elastomers, in particular the elastomer of the fluorine layer and the elastomer of the function body.

Furthermore, the fluorine layer may have an average layer thickness or fluorine penetration depth of 0.01 to 20 μm, or 0.2 to 12 μm, or in particular 2 to 8 μm. In one embodiment, the layer thickness of the fluorine layer corresponds to the penetration depth of the fluorine. The fluorine layer, in particular the layer thickness, is formed in particular by hydrogen atoms being substituted by fluorine atoms. It has been shown that a comparatively high layer thickness or fluorine penetration depth offers effective protection against blow-by gases and does not negatively affect the mechanical properties.

In one embodiment, it is provided that the fluorine layer has a first fluorine content and the function body has a second fluorine content, the first fluorine content being larger than the second fluorine content, in particular at least greater by 10% (at least by a factor of 1.1), may be at least greater by 20% (at least by a factor of 1.2), or in particular at least greater by 50% (at least by a factor of 1.5), greater by 70% (at least by a factor of 1.7) or greater by 90% (at least by a factor of 1.9). The higher fluorine content of the fluorine layer hereby offers special protection. The fluorine content is to be understood as an indication of the proportion by weight (in % by weight) of fluorine in relation to the corresponding fluorine layer or the corresponding function body.

In another embodiment, it may be provided that the fluorine layer comprises fluorine substituents on carbon atoms which are connected directly to a silicon atom of the siloxane or indirectly via exactly one CH2 group to a silicon atom of the siloxane or indirectly via exactly one CF2 group each to a silicon atom of the siloxane. In addition, the fluorine layer and the function body comprise fluorine substituents on carbon atoms which are each indirectly connected via a CH2-CH2 group to a silicon atom of the siloxane, in particular in the form of 3,3,3-trifluoropropyl groups on said silicon atom. In some embodiments, F3C-Si units, HF2C-Si units and/or H2FC-Si units are also components of the fluorine layer, i.e. here the fluorine substituents are directly connected to carbon atoms, which in turn are directly connected to silicon, for example as a trifluoromethyl group.

The elastomer material of the fluorine layer and/or the function body is a siloxane, in particular fluorinated siloxane, or in particular silicone. In some embodiments, it is a siloxane comprising 3,3,3-trifluoropropyl groups. The elastomer material of the function body, in particular the base elastomer material of the function body and the fluorine layer, may be FVMQ (designation according to DIN ISO 1629). Methyl vinyl silicone rubber with fluorine-containing groups, in particular 3,3,3-trifluoropropyl groups, has proven to be particularly suitable as the elastomer material of the function body, in particular as the base elastomer material of the function body and the fluorine layer. The elastomer material of the fluorine layer is an elastomer which is derived from the elastomer material of the function body, in particular FVMQ, wherein additional fluorination takes place, and/or wherein hydrogens in FVMQ have been substituted by fluorine. The elastomer material of the fluorine layer can then also be referred to as the fluorinated elastomer material of the function body and/or fluorinated FVMQ. Methyl vinyl silicone rubber with fluorine-containing groups has proved to be particularly suitable as the elastomer material of the fluorine layer, wherein at least some methyl groups and/or vinyl groups are additionally fluorinated.

In one embodiment, it is provided that the fluorine layer completely encloses the function body. Generally, it is also possible, that the fluorine layer surrounds the function body only partially. However, it is beneficial for chemical resistance to blow-by gases if the function body is completely enclosed, i.e. the function body is completely covered by the fluorine layer in all directions. If the function body is surrounded only partially by the fluorine layer, blow-by gases may penetrate the function body via uncovered areas of the function body and damage it. The protection is therefore even better with a complete enclosure.

In another embodiment it is provided that the elastomer component comprises at least one cantilever and/or undercut. The cantilever and/or undercut can be used to firmly fix the elastomer component better, for example in an opening. Furthermore, cantilevers and/or undercuts can be used to adjust, in particular increase, elastic restoring forces of elastomer components, in particular of valve members, such as seal washers of non-return valves, actuators, such as diaphragms of pressure control valves, or mushroom valves. It has been shown that the fluorination of the elastomer components does not negatively affect the mechanical properties of the function body. This means that fluorinated elastomer components can also be formed well and, in particular, cantilevers and/or undercuts can be formed. Furthermore, the elastomer components can first be formed and then fluorinated. In particular, the fluorination of an elastomer component that can be easily formed, such as fluorocarbon rubber, enables chemically resistant elastomer components with cantilevers and/or undercuts to be formed. With some conventional elastomer components, undercuts cannot be demolded because the elasticity and/or, in particular, the tear resistance is insufficient (for example, with an elastomer component made of pure silicone rubber).

In another embodiment it is provided that the elastomer component is configured rotationally symmetrically and/or, in particular, has a concave surface and/or section of the outside surrounding the center of gravity of the elastomer component. The elastomer component may be flat, especially disc-shaped, in at least one surface area and/or section of the outside.

The elastomer component may be a valve member of a control valve, in particular a non-return valve, a valve, a venting valve, a pressure relief valve or the like, and/or a diaphragm-shaped actuator, in particular a pressure control valves, and/or a seal, in particular a piston seal, shaft seal, housing seal, valve seal, or line seal.

In another embodiment, the elastomer component has a recess at the center of gravity, in particular a conical recess extending along an axis of rotational symmetry of the elastomer component. The recess along the rotational symmetry axis has a recess base, so that the recess is not continuous, but ends inside the elastomer component at the recess base. The elastomer component in a practical arrangement may be a seal washer, in particular a seal washer with a continuous, circular recess, for a non-return valve.

In one embodiment, the elastomer component is configured to be exposed to blow-by gases for a long time, in particular for at least 1, 2, 3, 4, or 5 years, in particular substantially without losing mechanical properties such as elasticity, elastic restoring force and/or tightness. Elastomer components may lose less than 95%, 90%, 85%, 80%, 70%, or 50% of their mechanical properties, such as elasticity, elastic restoring force, and/or tightness, over said period. In particular, elastomer components according to one embodiment, should be able to be exposed to temperature fluctuations between −40° C. and +150° C. and/or vacuum pressures between −0.9 bar, −0.7 bar, −0.5 bar, or −0.3 bar and 0 bar and/or pressures between 0 bar and 1.5 bar, 2.0 bar, 2.5 bar, or 3.0 bar, in particular without losing mechanical properties. The elastomer component in another embodiment is an elastomer component in the form of a mushroom valve, a seal washer for a non-return valve or a diaphragm for a pressure control valve.

The tensile strength of the elastomer material of the fluorine layer and/or of the function body may be 1 to 20 N/mm2, or in particular 5 to 15 N/mm2, or in particular 6 to 10 N/mm2, in accordance with ISO 37:2017-11 (DIN 53504: 2009-10). The elastomer component as a whole may have a comparable average tensile strength. The tensile strength may be particularly suitable for elastomer components in the form of sealing elements. The average density of the elastomer material of the fluorine layer and/or of the function body may be 1.4 to 1.7 g/cm3, in accordance with DIN EN ISO 1183-1 2013-04. The elastomer component as a whole may have a comparable average density.

The Shore A hardness of the elastomer material of the fluorine layer and/or of the function body may be 35 to 90, in particular 45 to 80, in particular 55 to 75, in accordance with DIN ISO 7619-1:2012-02. In some embodiments, the outside and/or the elastomer component on average has a comparable overall Shore A hardness. Shore A hardness has proven to be particularly suitable for elastomer components in the form of sealing elements.

One embodiment refers to a blow-by gas treating device, such as an oil separator, a valve, a compressor and/or a turbine, in particular a turbocharger, or the like, wherein an elastomer component formed according to the invention is accommodated in particular movably such that it is exposed to at least a part of the blow-by gas of the internal combustion engine. Blow-by gas treating devices may include in particular all components involved in the discharge of blow-by gases from the internal combustion engine and/or the supply, in particular by recirculation, of blow-by gases to the internal combustion engine. This may also include those components, which are used for sealing, such as sealing elements, in particular seal washers, of a system for the discharge and/or recirculation of blow-by gases. In addition to the combustion engine, blow-by gases can also be produced if they are led through a compressor, especially a turbocharger, before they are circulated back into the combustion engine. The recirculated blow-by gases may escape between the compressor drive shaft and the compressor housing, requiring separate sealing of these components and/or recirculation of the escaped blow-by gases. In addition, blow-by gases can escape, for example, when exhaust gases are passed through a turbine of a turbocharger, especially between the turbine drive shaft and the turbine housing, so that separate sealing of these components and/or recirculation of the escaped blow-by gases may be necessary.

In a system according to one embodiment for discharge and feeding, in particular for recirculation, of blow-by gas of an internal combustion engine, blow-by gas emerging from the crankcase or cylinder head is received and at least partially circulated back into the combustion cycle of the internal combustion engine, wherein at least one elastomer component formed according to an embodiment is arranged in the line system in such a way that it is exposed to at least part of the blow-by gas, in particular treating the latter. The treatment of blow-by gas refers to all functions of components involved in the discharge of blow-by gases from the internal combustion engine and/or the feeding line, in particular the recirculation of blow-by gases to the internal combustion engine. These functions include in particular the opening and closing of valves and the sealing of components exposed to blow-by gas.

The elastomer component according to one embodiment is available by fluorination, in particular according to the procedure described below.

An embodiment may include a method for producing an elastomer component, that is exposed to blow-by gases, in particular the elastomer component described above, comprising the following steps:

a) introduction of an elastomer substrate, in particular consisting of the second elastomer, into a process chamber and evacuation of the process chamber,
b) supply of a first gas composition comprising elemental fluorine gas, such that the process chamber comprises elemental fluorine gas at a process chamber concentration,
c) tempering the elastomer substrate in the process chamber for a tempering period under conversion of the first gas composition into a second gas composition and under forming of the fluorine layer of the elastomer component by fluorinating the surface of the elastomer substrate,
d) removing of the second gas composition comprising elemental fluorine gas and hydrogen fluoride from the process chamber,
e) removing of the elastomer component from the process chamber.

With the procedure described above, a complete enclosure of the function body, in particular the elastomer core, by the fluorine layer can be ensured particularly efficiently. Thereby an increased concentration of fluorine substituents in the elastomer material of the fluorine layer is achieved by treatment with elemental fluorine gas.

fluorinating of the elastomer substrate in step (c) does not mean fluorination of all areas of the elastomer substrate. Areas of the elastomer substrate remote from the surface are regularly shielded from the fluorine gas. Rather, the outside of the elastomer substrate may be fluorinated under forming of the fluorine layer, while the elastomer core is not fluorinated. If fluorine penetrates into the elastomer substrate and fluorination also occurs deeper inside, the layer thickness of the fluorine layer increases accordingly. In particular, the penetration depth of the fluorine corresponds to the layer thickness of the fluorine layer. The fluorine layer, in particular the layer thickness, is formed in particular by the fact that hydrogen atoms are substituted by fluorine atoms.

One embodiment of the method provides that the first gas composition comprises at least one inert gas in addition to elemental fluorine gas. The at least one inert gas may be nitrogen, helium, or argon. Tempering in step c) may be performed at 10 to 100° C., in particular at 20 to 60° C., or in particular at 25 to 40° C. The treatment at these temperatures may be gentle, wherein efficient fluorination is occurring at the same time.

The layer thickness can be influenced by the tempering period and process chamber concentration of the elementary fluorine gas. The tempering period may be set via the desired layer thickness of an elastomer component. For this purpose, tests are performed with different tempering period, in particular residence times, and the layer thickness of the fluorine layer, in particular the penetration depth, is then measured. Thereby, the ideal tempering period for certain layer thicknesses can be determined by several tests. According to the field of application, elastomer material, and/or geometry of the elastomer component, thereby the ideal residence time is determined for each specific component. In a functional embodiment, it may also be provided that the pressure in the process chamber after evacuation in step a) is less than 10-2 mbar, in particular less than 10-3 mbar.

Another embodiment further refers to the use of an elastomer component comprising a function body made of an elastomer material and a fluorine layer arranged on the outside of the function body, in particular the elastomer component described above, in a blow-by gas treating device, in particular the device described above, and/or in a system for discharge and feeding of blow-by gas, in particular in the system described above, wherein the elastomer component is exposed to blow-by gases. The use of elastomer components as valve members of a control valve, in particular a non-return valve, a valve, a venting valve, a pressure relief valve or the like, and/or as a diaphragm-shaped actuator, in particular a pressure control valve, and/or as a seal may be used in some embodiments. Another embodiment may use of the elastomer component as a sealing element for retaining blow-by gases of an internal combustion engine, in particular a passenger car internal combustion engine, and/or of a compressor or a turbine, in particular a turbocharger. The use of the elastomer component described above may be as a suction pipe seal, engine oil seal, intake manifold seal, quick coupling seal and/or fuel system seal.

One embodiment also refers to the use of the elastomer component described above to reduce the precipitation of pollutants from blow-by gases in the elastomer component, in particular to reduce the precipitation of heavy metals, such as manganese. Hereby the fluorine layer is used to effectively retain pollutants. According to one embodiment, heavy metals are metals with a density of at least 5 g/cm3 in elemental state. While a friction reduction for fluorinated components is well known, the use of a fluorine layer to prevent the penetration of pollutants from blow-by gases into the elastomer core is still unknown. Another embodiment also refers to the use of the elastomer component described above to prevent or reduce valve freezing.

Furthermore, the present embodiments refer to an elastomer component, in particular an elastomer component as described above, which is exposed to blow-by gases of an internal combustion engine, wherein the elastomer component is obtained by fluorinating an elastomer substrate with fluorine gas, in particular by the method described above.

With the present embodiments, it was achieved to provide improved elastomer components that are particularly resistant to blow-by gases. Even components with complex geometries can be produced by the method for producing.

### BRIEF DESCRIPTION OF THE DRAWINGS

Further advantages, effects, and embodiments of this invention can be seen in the figures below.

FIG. 1 shows a schematic view of blow-by gas circuit within an internal combustion engine;

FIG. 2 shows a cross-sectional view of a blow-by gas recirculation system;

FIG. 3 shows a cross-sectional view of a non-return valve built into a blow-by gas recirculation system;

FIG. 4 shows a perspective cross-sectional view of the valve member of the non-return valve in FIG. 4;

FIG. 5 shows a cross-sectional view of a mushroom valve built into a blow-by gas recirculation system;

FIG. 6 shows a perspective cross-sectional view of the mushroom valve in FIG. 5;

FIG. 7 shows a cross-sectional view of a pressure control valve built into a blow-by gas recirculation system; and

FIG. 8 shows a perspective cross-sectional view of the actuator of the pressure control valve in FIG. 7.

### DETAILED DESCRIPTION

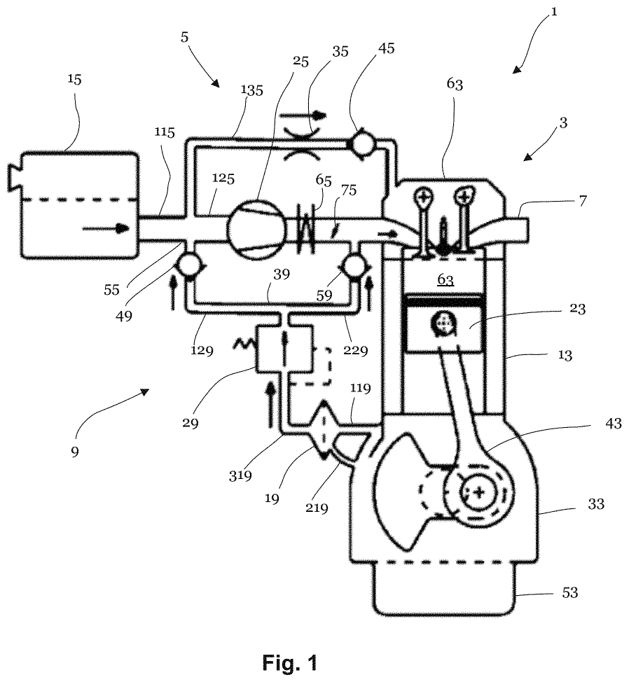

To illustrate possible fields of application of the present embodiments, FIG. 1 shows an exemplary schematic blow-by gas circuit 1 of an internal combustion engine. It comprises a reciprocating piston engine 3, an air inlet 5 feeding the reciprocating piston engine, an exhaust 7 and a blow-by gas recirculation system 9. The reciprocating piston engine 3 comprises a cylinder 13, a piston 23 located in the cylinder, a crankcase 33 connected to the cylinder, a crank drive 43 coupled to the piston, and an oil pan 53. During the combustion process in the reciprocating piston engine 3, in particular during the compression and expansion of the fuel mixture, blow-by gases, in particular unburned fuel mixtures, engine oils and/or exhaust gases, flow between piston 23 and cylinder 13 into the crankcase 33. To reduce the blow-by gas flow flowing into the crankcase 33, piston seals (not shown), in particular sealing rings are used, which seal the combustion chamber 63 with respect to the crankcase. One field of application of the elastomer component according to the invention are seals between cylinder head 63 and cylinder 13, which are not shown, in order to prevent the escape of blow-by gases into the environment. Another conceivable field of application for the elastomer component according to the invention relates generally to the sealing of pistons or other moving parts exposed to blow-by gases.

In the blow-by gas circuit shown, the crankcase 33 is connected to the air supply 5 of the reciprocating piston engine 3 via a blow-by gas recirculation system 9. In the example shown, blow-by gases are passed from the crankcase 33 via an oil mist separator 19 to a pressure control valve 29. Therein, the gases are fed to the separator 19 via a separator feeding line 119. Separated oil is returned to the crankcase 33 via an oil return line 219. The remaining blow-by gas is fed to the pressure control valve 29 via a separator outlet line 319. Depending on the implementation of the blow-by gas circuit, seals between the separator feeding line 119, the oil return line 219, the separator outlet line 319, the oil mist separator 19, and/or the crankcase can be embodied as elastomer components according to the invention. It is clear that all the seals exposed to blow-by gases listed so far and below can be embodied as elastomer components according to the invention.

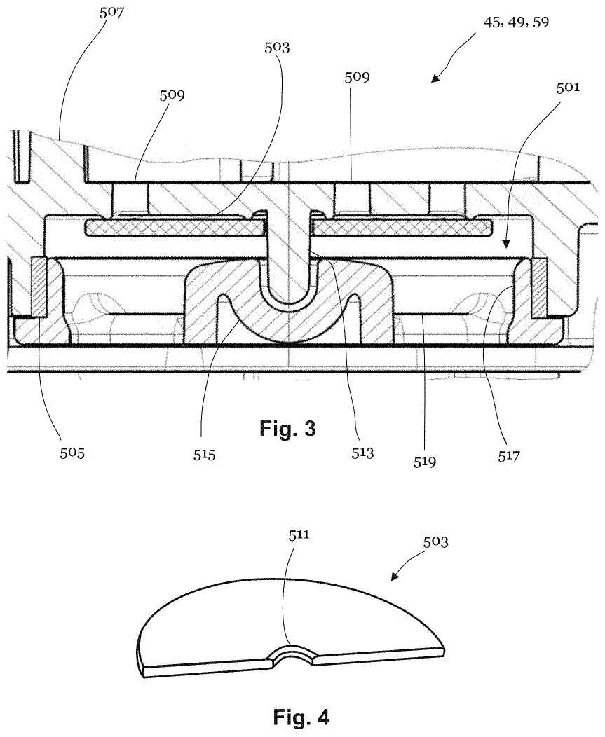

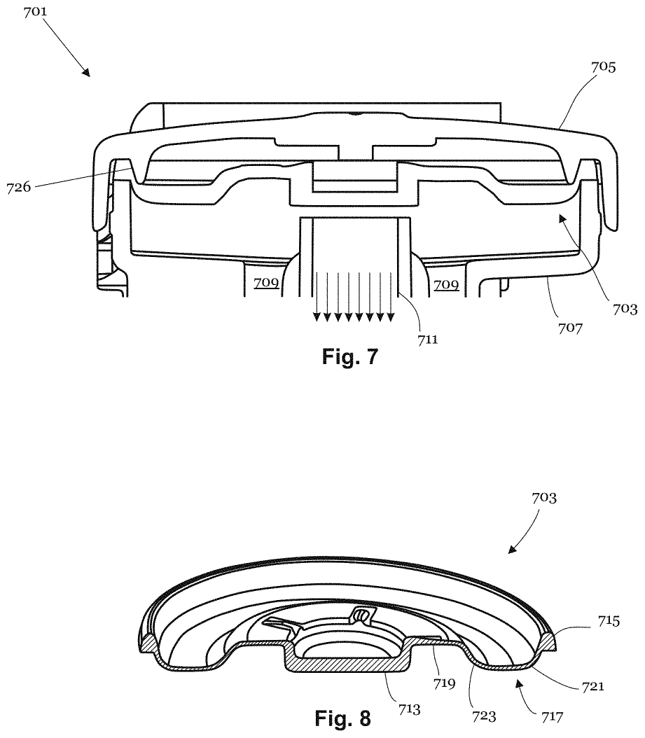

The pressure in the crankcase is adjusted via the pressure control valve 29. It has proven advantageous for pressure control valves in blow-by gas recirculation systems to use valves with pressure control diaphragms as shown in FIGS. 7 and 8, for example. It is particularly advantageous to implement the actuator, in particular the diaphragm 703, of the pressure control valve as an elastomer component in accordance with the invention. In the circuit shown, blow-by gases leaving the control valve are divided into several, in particular two, separate suction feeding lines 129, 229 via a flow splitter, in particular a T-piece. Seals between the lines and the flow splitter can be implemented as an elastomer component in accordance with the invention. The suction feeding lines 129, 229 and the air supply 5 are separated from each other in the presented blow-by gas circuit 1 by non-return valves 49, 59. It has been shown that non-return valves with seal washers 503, in particular as shown in FIGS. 3 and 4, are particularly advantageous for use in blow-by gas circuits. It has been shown to be particularly advantageous to configure the seal washers as elastomer components in accordance with the invention. The use of elastomer components according to one embodiment, in particular in the form of seal washers 503, in non-return valves 49, 59, is shown in FIG. 3, in blow-by gas circuits between suction feeding line 129, 229 and the air supply 5.

The separate suction feeding line 129, 229 supplies to different admission points of the air inlet 5. Depending on the operating condition, in particular the pressure in the crankcase and the intake pressure in the air inlet 5, the blow-by gas flow is supplied to the air inlet 5 via one or both suction feeding line 129, 229. A suction feeding line 129 supplies the blow-by gas flow to an intake flow splitter 55 between an intake air filter 15 and a compressor 25 where blow-by gas mixes with fresh air. The resulting mixture of air and blow-by gas can be supplied from the intake flow splitter 55 to the reciprocating piston engine 3 via a compressor line 125 and a ventilation system 135. In compressor line 125, the air-blow-by-gas mixture is supplied to cylinder 13 via a compressor 25, an intercooler 65 and a throttle valve 75. The air-blow-by-gas mixture can escape between the drive shaft of compressor 25, which is not shown, and the compressor housing of a turbocharger. Similarly, blow-by gases can escape between the output shaft of a turbine, especially a turbocharger, and the turbine casing. In order to reduce the escape of blow-by gas via the compressor and/or turbine, seals between the input shaft of a compressor and a compressor casing and/or between the output shaft of a turbine and a turbine casing may be implemented as elastomer components according to the invention. It is clear that the blow-by gas recirculation system 9 illustrated here can also be provided on compressor and turbine housings, in particular for turbochargers, to recirculate escaping blow-by gases. Via the ventilation system 135, the air-blow-by-gas mixture can be supplied from the flow splitter to the reciprocating piston engine via a throttle 35 and a non-return valve 45, like a mushroom valve. The second suction feeding line 229 supplies the blow-by gas flow to compressor line 125 behind the throttle cap. It is clear, that in particular all the seals and valve members and actuators of valves, and valves exposed to blow-by gases shown with reference to FIG. 1 can be implemented as elastomer components in accordance with the invention.

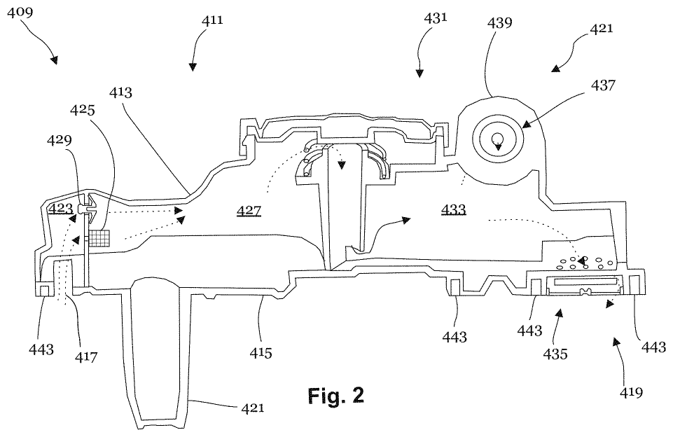

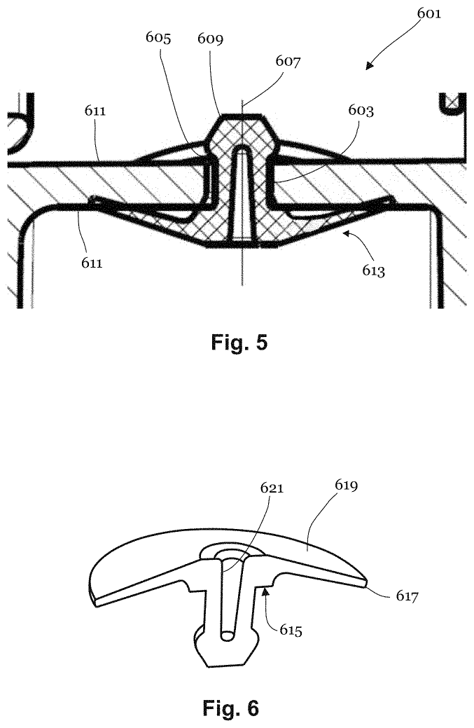

FIG. 2 shows a cross-sectional view of an exemplary system for the discharge and supply of blow-by gases, in particular a recirculation system 409 for blow-by gas. It comprises a recirculation system housing 411, in particular comprising a housing body 413 and a housing base 415. The blow-by gases are feed into the recirculation system via a return inlet 417 and diverted from the recirculation system via return outlets 419, 421. From the crankcase, the gas first flows through the return inlet 417, through an opening in the housing base, into a first recirculation chamber 423. From the first recirculation chamber 423, the blow-by gas flows, through an oil separator 425, into a second recirculation chamber 427. The oil separator can be implemented as a deflecting separator. In particular, a bypass valve 429 may also be provided through which the blow-by gas may flow from the first recirculation chamber 423 to the second recirculation chamber 427, e.g. at high crankcase pressure and/or clogged oil separator. A possible embodiment of a bypass valve 429 is shown in detail in FIGS. 5 and 6 as a non-return valve, in particular in the form of a mushroom valve. The blow-by gas is supplied from the second working chamber 427 via a pressure control valve 431 to a third recirculation chamber 433. One embodiment of a pressure control valve 431 in the recirculation system 409 is shown in detail in FIG. 7 and FIG. 8. From the third recirculation chamber 433 the blow-by gas is discharged from the recirculation system via non-return valves 435, 437 via the return outlets 419, 421, and supplied in particular to a suction feeding line 125. One embodiment of the non-return valve 435, 437 from FIG. 2 is shown in detail in FIG. 3 and FIG. 4. In particular, the blow-by gas in partial load operation of the engine can be diverted from the recirculation outlet via a non-return valve 435 arranged in the housing base. In full-load operation, however, the blow-by gas should be diverted from the recirculation outlet 421 in particular via a cylindrical intake socket and a non-return valve mounted therein. Valve members, such as seal washers of non-return valves, mushroom valves, and/or actuators, such as diaphragms, are implemented as elastomer components according to the invention. Furthermore, seals between the housing body and the housing base that are not shown may be implemented as elastomer components according to one embodiment.

FIG. 2 also shows an oil return socket through which separated oil is discharged from the second return chamber 427. Here, too, it is possible to use elastomer components according to the invention in the form of valve members, actuators, and/or seals. In addition, elastomer components according to the invention for seals 443 can be employed between the housing base and the crankcase or engine housing.

FIG. 3 shows an advantageous non-return valve 45, 49, 59 for use in blow-by gas circuits 1. It comprises a valve body 501 and a valve member 503, in particular in the form of a seal washer 503. A perspective cross-sectional view of the valve member is shown in FIG. 4. The valve body 501 is sealed by a sealing element 505, a sealing ring, against a housing 507, for example of a recirculation system. Such a non-return valve may, for example, be located between an air inlet 5, in particular upstream of a suction line 115, and a recirculation system housing 411, 507, in particular a return inlet 417 thereof, as shown in FIG. 2. The charging pressure of the suction line 115 is usually two bars. Due to pressure differences between the charging pressure of the suction line and the blow-by gas pressure, the valve member is pushed in the direction of the valve body so that the blow-by gas flow can flow into the valve body through openings 509 in the recirculation system housing 507. The valve member 503 may be implemented as an elastomer component according to the invention. The sealing means 505 is also designed as an elastomer component according to the invention. The valve member may be implemented as disc-shaped and has an outer diameter and a thickness. In particular, the valve member has an opening 511, in particular a circular hole. The opening may be in the center of the valve member. In particular, the size of the opening correlates with a guide pin 513 protruding from the housing. The guide pin may have a cylindrical guide surface. In particular, the valve member is mounted slidingly, especially on the guide pin. In the closed state, the valve member rests against the housing and closes the housing openings 509. In the open state, the valve member is moved away from the housing, in particular pressed against a counter bearing 515 of the valve body. The valve body comprises an annular outer contour 517, which is connected to the counter bearing 515, in particular via radially inwardly extending ridges 519. Recesses through which blow-by gases can flow are provided between the ridges 519. The thickness and/or outer diameter of the valve member may be set such that the valve member 503 bends around the thrust bearing 515 depending on the pressure difference at the valve between charging pressure and intake pressure, so that the flow resistance of the non-return valve is reduced in the open state. A ratio of the outer diameter of the valve member to the thickness of the valve member may be at least 10/1, 12/1, 15/1, 17/1, 19/1 and/or up to 21/1, 25/1, 29/1, 33/1, 37/1 or 41/1. A ratio of the outer diameter of the valve member to the outer diameter of the counter bearing 515 may be at least 1.5/1, 1.7/1, 1.9/1 and/or at most 2.1/1, 2.3/1, 2.5/1.

The counter bearing 515 has a trough into which the pin protrudes and which is shaped complementary to the end of the guide pin facing away from the housing, and which is in particular closed in the direction of flow. A phase is provided on the outside of the annular outer contour 517 of the valve body, which is formed in particular complementary to a phase of the housing for inserting a sealing element 505, a sealing ring. The valve member 503 shown in FIGS. 3 and 4 is in particular configured to be exposed to blow-by gases with temperature ranges from −40° C. to +150° C., volume flows of 200 l/min, and/or pressures of two bars for a long time, in particular several years, without losing significant mechanical properties.

FIG. 5 shows an elastomer component according to one embodiment mounted into a blow-by gas recirculation system, in particular in the form of a mushroom valve 601. FIG. 6 shows a perspective cross-sectional view of the elastomer component in FIG. 5. The elastomer component may be inserted in a system for discharging and feeding blow-by gases, in particular in a recirculation system for blow-by gases. The elastomer component 601 has a cylindrical base body 603 with a rotation axis 607, which extends through an opening 605 when installed. At one end of the base body 603, a contact section 609 is provided for supporting the elastomer component against a wall 611 of the recirculation system forming the opening 605. In the assembled state, the contact section extends radially from the axis of rotation 607 beyond the opening 605. The contact section 609 may have a trapezoidal cross-section, wherein in particular a wider end of the trapezoid is resting against the wall 611 of the recirculation system. On the side of the base body 603 opposite the contact section 609, the elastomer component 601 has a disc-shaped, in particular concave, sealing body 613 for sealing passage openings which are not shown. In particular, blow-by gases exert pressure on the sealing body via the passage openings not shown. If a predetermined pressure, in particular 0.3 bar, is exceeded, the sealing body deforms, in particular elastically, in such a way that a passage, in particular an annular gap, is formed between the sealing body 613 and wall 611. In this condition, blow-by gases can pass through the passage openings and the passage of the elastomer component, in particular the non-return valve, in particular in the form of a mushroom valve. A counter bearing surface 615 extends radially outwards from the outer surface of the base body on the side of the sealing body 613 facing the contact section. The counter bearing surface extends annularly in radial direction, in particular in a plane defined by the axis of rotation as normal vector. Furthermore, the disc-shaped sealing body 613 has a radial, in particular circular outer edge 617 on the side facing the contact section 609. If the pressure is below the predetermined pressure, the outer edge 617 is pressed against the wall 611 of the recirculation system, in particular by elastic deformation restoring forces, so that blow-by gases cannot pass the elastomer component, in particular the non-return valve, in particular in the form of a mushroom valve, through the passage openings. A conical section 619 of the disc-shaped sealing body 613 extends radially inwards from the outer edge 617 and axially away from the contact section 609. The inclination of the conical section in the assembled, unloaded state of the elastomer component is 5°, 10°, 15°, 20°, 25°, or 30°. Due to the pressures of blow-by gases, the sealing body deforms, in particular elastically, in such a way that the angle of inclination is reduced. The thickness of the conical section 619 increases radially from the outside to the inside in particular. Furthermore, a recess 621 is provided in the elastomer component, in particular a conical recess. The recess 621 extends axially, in particular centrally, from the side of the sealing body 613 facing away from the contact section into the base body 603, in particular through the base body into the contact section 609. The recess 621 is open on the sealing body side and closed on the contact section side.

The elastomer component shown in FIGS. 5 and 6 is particularly configured to endure blow-by gases in a temperature range from −40° C. to +150° C., volume flows from 20 l/min to 200 l/min, and/or pressures of two bars for a long time, in particular several years, without losing significant mechanical properties. Furthermore, the elastomer component according to the invention is configured to provide an elastic closing pressure of at least 150 mbar, 250 mbar, and/or a maximum of 300 mbar, 350 mbar, 400 mbar, or 500 mbar.

Another embodiment of an elastomer component according to the invention is shown in FIGS. 7 and 8. FIG. 7 shows a pressure control valve comprising a valve cover 705, an elastomer component, in particular as an actuator in the form of a diaphragm 703, a housing portion 707 of a recirculation system, a blow-by gas supply duct 709 and an intake socket 711. FIG. 8 shows a perspective cross-sectional view of the elastomer component from FIG. 7. It comprises in particular a disc-shaped throttle surface 713, which is formed in particular complementary to the outer wall of the intake socket 711, the intake socket being formed as a hollow cylinder. In particular, the distance between the throttle surface and the intake socket 711 varies depending on the intake pressure by moving the throttle surface towards or away from the intake socket, in particular by elastic deformation of the elastomer component. The pressure in the crankcase is controlled by the variable distance between the throttle surface and the intake socket 711. The elastomer component further comprises a mounting portion 715 for mounting the elastomer component, between the valve cover 705 and the housing portion of the recirculation system 707 The mounting portion 715 and the throttling surface 713 may be connected to each other via a spring section 717 of the elastomer component, in particular when implemented in one piece. In one embodiment, the elastomer component is implemented rotationally symmetrical. Starting from the central axis of rotation, the disc-shaped throttle surface 713 extends radially, in particular planar, outwards. The spring section 717 extends radially from the outer surface of the throttle surface 713 to the mounting portion 715, the spring section having in the radial direction in particular a curved contour, in particular an S-shaped contour.

The spring section 717 extends particularly starting from the radial outer edge of the throttle surface 713 in a first axial direction, away from the intake socket, and then radially outwards to the mounting portion 715. The spring section may have two disc-shaped surfaces, which are spaced apart from one another in the axial direction. In particular, a first disc-shaped spring surface 719, which is connected to the throttle surface 713, and is axially spaced from the throttle surface 713 in a first direction and, in particular, a second spring surface 721, which is connected to the mounting portion 715, is axially spaced from the first spring surface 719 in the opposite axial direction. The first axial direction may point away from the intake socket and the second axial direction towards the intake socket. Furthermore, in the unstressed state of the elastomer component, the first spring section extends axially substantially at the level of the mounting portion 715 and/or the second spring section 721 extends substantially at the level of the throttling surface 713. The two disc-shaped spring sections may be connected to one another via a conical spring section 723. One of the spring faces 719, 721, in particular the first spring face 719, serves to receive a spring, in particular a compression spring, which exerts a force on the elastomer component, in particular against the suction pressure.

As shown in FIG. 7, the elastomer component according to the invention, in particular in the form of a diaphragm 703, is attached to the outside of the elastomer component via an annular connecting portion. The mounting potion 715 is enclosed by the valve cover 705 on the one side and the housing portion of the recirculation system on the other side. Therefor in particular, a recess 726 complementary to the mounting portion 715 is provided in the valve cover.

The pressure control valve, in particular the elastomer component, in particular in the form of a diaphragm for a pressure control valve, is configured to set a crankcase pressure between +100 mbar and −200 mbar, or between +50 mbar and −100 mbar, may be between +20 mbar and −100 mbar, at an intake pressure between −0.9 bar, −0.7 bar, −0.5 bar, or −0.3 bar and 0 bar. Further, the pressure control valve, in particular the elastomer component, is configured to endure temperatures of −40° C. to 150° C. in the long term and to permit blow-by gas volume flows into the intake sockets 711 between 0 l/min and 200 l/min.

### LIST OF REFERENCE NUMERALS

1 blow-by gas circuit
3 reciprocating piston engine
5 air inlet
7 exhaust
9 recirculation system
13 cylinder
19 oil mist separator
23 piston
25 compressor
29 pressure control valve
33 crankcase
35 throttle
39 flow splitter
43 crank drive
49, 45, 59 non-return valve
53 oil pan
63 cylinder head
75 throttle valve
119 oil separator feeding line
125 compressor line
129, 229 suction feeding line
135 ventilation system
219 oil return line
249 valve body
319 separator outlet line
329 diaphragm
409 recirculation system
411 recirculation system housing
413 housing body
415 housing base
417 return inlet
419, 421 return outlets
423 first recirculation chamber
425 oil separator
427 second recirculation chamber
429 bypass valve
431 pressure control valve
433 third recirculation chamber
435, 437 non-return valves
439 cylindrical intake socket
441 oil return socket
443 seals
501 valve body
503 seal washer
505 sealing means
507 housing
509 housing openings
511 opening
513 guide pin
515 counter bearing
517 annular outer contour
519 valve housing ridges
601 mushroom valve
603 cylindrical base body
605 bypass opening
607 axis of rotation
609 contact section
611 wall of the recirculation system
613 disc-shaped sealing body
615 counter bearing surface of the sealing body
617 outer edge of the disc-shaped sealing body
619 conical section
621 conical recess
701 pressure control valve
703 diaphragm
705 valve cover
707 housing portion of a recirculation system
709 blow-by gas supply duct
711 intake socket
713 disc-shaped throttle surface
715 mounting portion
717 spring section
719, 721 disc-shaped spring sections
723 conical spring section
726 recess in control valve cover

1. An elastomer component comprising:
a function body made of an elastomer material; and
a fluorine layer arranged on the outside of the function body;
wherein the elastomer component is exposed to blow-by gases by an internal combustion engine.

2. The elastomer component according to claim 1, wherein the function body is formed by a first elastomer and the fluorine layer is formed by a second elastomer, further wherein the first elastomer differs from the second elastomer in that it comprises adsorbed fluorine.

3. The elastomer component according to claim 1, wherein the fluorine layer and the function body are formed from the same elastomer material, further wherein the fluorine layer is formed by adsorption of fluorine in the elastomer material through fluorination of the surface of the function body with introduced elastomer material, further wherein absorption of fluorine atoms at the polymer chains of the elastomer material is by introduction of fluorine on the surface of the function body.

4. The elastomer component according to claim 3, wherein the elastomer material of the fluorine layer or the function body comprises a siloxane.

5. The elastomer component according to claim 3, wherein the elastomer material of the fluorine layer or the function body comprises a methyl vinyl silicone rubber with fluorine-containing groups.

6. The elastomer component according to claim 3, wherein the elastomer material of the fluorine layer or the function body comprises a tensile strength of 1 to 20 N/mm².

7. The elastomer component according to claim 3, wherein the elastomer material of the fluorine layer or the function body comprises an average density of 1.4 to 1.7 g/cm³.

8. The elastomer component according to claim 3, wherein the elastomer material of the fluorine layer or the function body comprises a Shore A hardness of 35 to 90.

9. The elastomer component according to claim 1, wherein at least one side of the function body facing a blow-by gas comprises the fluorine layer, and the function body is completely enclosed by the fluorine layer.

10. The elastomer component according to claim 1, wherein the fluorine layer has an average layer thickness or fluorine penetration depth of 0.01 to 20 μm.

11. The elastomer component according to claim 1, wherein the fluorine layer has a first fluorine content and the function body has a second fluorine content, wherein the first fluorine content is larger than the second fluorine content.

12. The elastomer component according to claim 1, wherein the elastomer component comprises at least one cantilever or undercut.

13. The elastomer component according to claim 1, wherein the elastomer component comprises a valve member of a control valve, a non-return valve, a valve, a venting valve, a pressure relief valve or a diaphragm-shaped actuator, and comprises pressure control valves, or a seal, including a piston seal, shaft seal, housing seal, valve seal, or line seal.

14. The elastomer component according to claim 1 available by fluorination, wherein the elastomer component is formed by:
introducing an elastomer substrate into a process chamber;
evacuating of the process chamber;
supplying of a first gas composition comprising elemental fluorine gas, such that the process chamber comprises elemental fluorine gas at a process chamber concentration;
tempering the elastomer substrate in the process chamber for a tempering period under conversion of the first gas composition into a second gas composition and under forming of the fluorine layer of the elastomer component by fluorinating the surface of the elastomer substrate;
removing of the second gas composition comprising elemental fluorine gas and hydrogen fluoride from the process chamber; and
removing of the elastomer component from the process chamber.

15. A method for producing an elastomer component exposed to blow-by gases, the method comprising:
introducing an elastomer substrate into a process chamber;
evacuating of the process chamber;
supplying of a first gas composition comprising elemental fluorine gas, such that the process chamber comprises elemental fluorine gas at a process chamber concentration;
tempering the elastomer substrate in the process chamber for a tempering period under conversion of the first gas composition into a second gas composition and under forming of the fluorine layer of the elastomer component by fluorinating the surface of the elastomer substrate;
removing of the second gas composition comprising elemental fluorine gas and hydrogen fluoride from the process chamber; and
removing of the elastomer component from the process chamber.

16. The method according to claim 15, wherein the first gas composition comprises elemental fluorine gas and at least one other gas selected from a group consisting of nitrogen, helium, and argon, or another inert gas.

17. The method according to claim 15, wherein the tempering is performed at 10 to 100° C., in particular 20 to 60° C., preferably at 25 to 40° C.

18. The method according to claim 15, wherein the pressure in the process chamber is less than 10⁻² mbar after the evacuating.

19. The method according to claim 15, further comprising:
arranging a fluorine layer on the outside of a function body in a blow-by gas treating device, wherein elastomer components comprise the function body made of an elastomer material, wherein the elastomer component is exposed to blow-by gases.

20. The method according to claim 19, further comprising:
increasing a chemical stability of the elastomer components to reduce the precipitation of pollutants from blow-by gases in the elastomer component to reduce the precipitation of manganese.

21. A blow-by gas treating device comprising:
an elastomer component comprising:
a function body made of an elastomer material; and
a fluorine layer arranged on the outside of the function body;
wherein the elastomer component is moveable and is exposed to at least a part of blow-by gas of an internal combustion engine.

22. The device of claim 21, wherein the blow-by gas treating device comprises an oil separator, a valve, a compressor or a turbine.

23. An elastomer component exposed to blow-by gases by an internal combustion engine, wherein the elastomer component is formed by:
introducing an elastomer substrate into a process chamber;
evacuating of the process chamber;
supplying of a first gas composition comprising elemental fluorine gas, such that the process chamber comprises elemental fluorine gas at a process chamber concentration;
tempering the elastomer substrate in the process chamber for a tempering period under conversion of the first gas composition into a second gas composition and under forming of the fluorine layer of the elastomer component by fluorinating the surface of the elastomer substrate;
removing of the second gas composition comprising elemental fluorine gas and hydrogen fluoride from the process chamber; and
removing of the elastomer component from the process chamber.

24. A system configured for discharge and feeding of blow-by gas of an internal combustion engine, wherein the system comprises:
a blow-by gas emerging from an engine bay of the internal combustion engine that is received and at least partially circulated back into a combustion cycle of the internal combustion engine; and
at least one elastomer component arranged to be exposed to at least part of the blow-by gas.
